(19) United States
(12) Patent Application Publication
(10) Pub. No.: US 2014/0148930 A1
(43) Pub. Date: May 29, 2014

(54) GAMIFIED STUDY ENVIRONMENT

(71) Applicant: Christopher J. Goodwin, Los Osos, CA (US)

(72) Inventor: Christopher J. Goodwin, Los Osos, CA (US)

(21) Appl. No.: 13/687,961

(22) Filed: Nov. 28, 2012

(51) Int. Cl. G09B 5/00

(52) U.S. Cl. CPC G09B 5/00
USPC 700/92

(57) ABSTRACT

A method and corresponding apparatus to perform the method are provided to provide a gamified study environment, the method comprising tracking time spent studying by a plurality of users, multiplying the various tracked times by various multiplier factors relating to the level of the subject at which the various users studied at and a groove factor achieved by various users to generate experience points of the various users. A user is then able to view the various experience point of the various other users in addition to other possible aspects.

### BACKGROUND OF THE INVENTION

1. Field of the Invention

The present invention relates generally to methods of tracking studying, and more specifically to gamifying studying between multiple users.

2. Discussion of the Related Art

Studying a subject, such as one does in preparation for tests, homework, and in general academia, is often viewed as a chore by children and adults alike. Motivation to study can be diminished or hindered by various distractions or a general dislike of the subject matter or the study process. A lack of immediate feedback or praise for spending quality time studying can also add to the lack of motivation to study. These motivational issues are endemic to academia and can result in decreased local and national academic performance.

Additionally, teachers or other subject administrators often search for efficient methods to manage study content and curriculum as well as to send and receive study materials, assignments, quizzes, tests, and the like. Further, teachers desire a single interface by which to grade student work and maintain those grades. Parents, legal guardians, or other individuals responsible for ensuring a child, minor, or other dependant properly pursues an education often seek efficient methods by which to review the study habits of those under their care or responsibility.

Presently, various solutions to these problems involve providing a virtual world in which students can play as well as occasionally study. This form of studying, however, is inefficient as the student may waste time with various recreational distractions rather than focusing on the subject of study. Further, the various quick study sessions interspersed with recreational activities prevents the student from achieving benefits associated with continuous studying for longer periods of time. Other solutions provide simple study timers to keep track of the study habits of the student. These solutions, however, do not address the motivation issues described herein. Further, these solutions are presently limited to quantitative aspects of studying and do not factor in qualitative aspects. The effectiveness of the study time is not represented accurately without such qualitative analysis.

### SUMMARY OF THE INVENTION

Several embodiments of the invention advantageously address the needs above as well as other needs by providing a method and corresponding apparatus to perform the method comprising tracking time spent studying a subject by at least a first and second user and multiplying tracked study times by respective multiplier factors relating to the level of the subject each user studied and a groove factor achieved by each user to generate respective experience points values. The method further comprises enabling at least the first user to view at least the experience points for at least the first second users.

By this, a user is provided with an environment in which they can view their earned experience points value which is based on both quantitative and qualitative measures. The environment also allows for the user to compare their experience points value against other users. The competitive nature of the comparison helps foster a gamified environment in which students are encouraged to out-study each other in an attempt to achieve the highest experience point value. Other useful embodiments are possible through such an environment to further gamify studying.

Gamified studying in the manner described herein has the benefit of motivating students to increase the amount of time spent studying and lengthen the periods of time spent studying, as well as motivating students to excel in the various subjects due to the weighted time tracking aspect. Thus, both an individual student's academic achievement and the academic achievement of an entire group can be increased.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is an illustration of a system configured to provide a gamified study environment in accordance with various embodiments.

FIG. 2 is a flow diagram illustrating a method of gamifying study time amongst a plurality of users in accordance with various embodiments.

FIG. 3 is a flow diagram illustrating additional aspects of the method of gamifying study time illustrated in FIG. 2.

FIG. 4 is an example of a portion of a user interface of a gamified study environment in accordance with various embodiments.

FIG. 5 is another example of a different portion of the user interface of the gamified study environment in accordance with various embodiments.

FIG. 6 is a further example of a different portion of the user interface of the gamified study environment in accordance with various embodiments.

FIG. 7 is an example of a different portion of the user interface of the gamified study environment in accordance with various embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

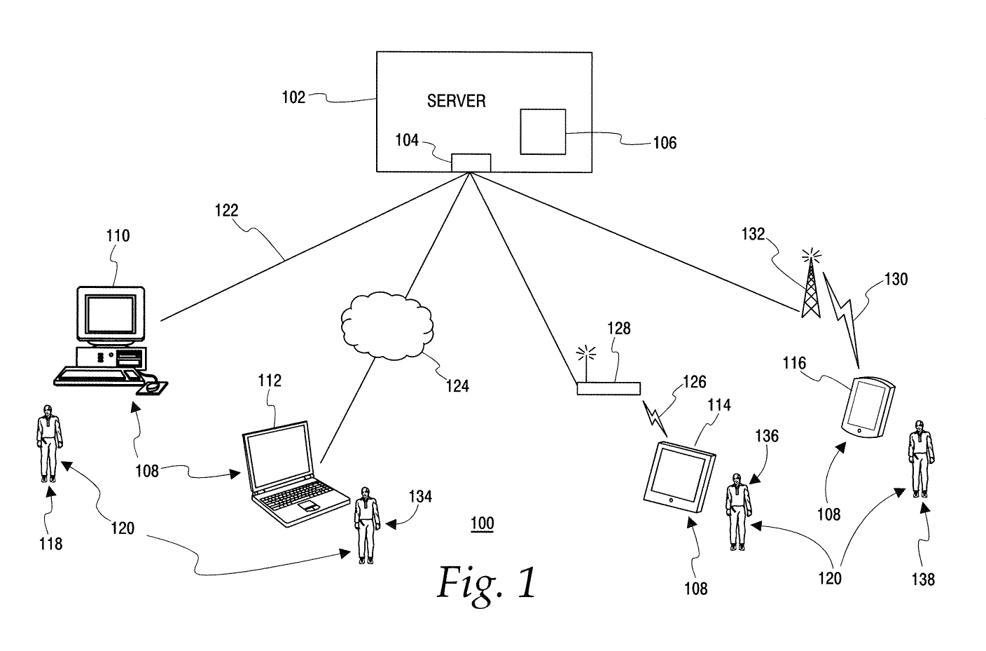

Referring first to FIG. 1, an illustration of a system 100 configured to provide a gamified study environment is in accordance with various embodiments is shown. The system comprises a server 102, mainframe, or other centralized network capable device. The server 102 comprises a network interface 104 and at least one processing device 106. This system 100 or infrastructure may also comprise various other user devices 108 per various embodiments, such as, for example, a personal computer (PC) 110, a laptop computer 112, a tablet computer 114, a smart phone 116, or other known user devices 108 and computing devices not specifically depicted such as minicomputers, workstations, client workstations, personal digital assistants (PDAs), notebooks, subnotebooks, netbooks, hand-held computers, pocket computers, stationary and portable computers, wearable computers, or even one or more devices specifically designed to implement the method described herein. All of these user devices 108 are known in the art, but the method is not limited to known computing platforms. Future technologies may develop that are capable of performing the described method that are fully contemplated and are considered within the ambit of this disclosure.

As depicted, the server 102 comprises at least one network interface 104 and at least one processing device 106. The server 102 itself may not be a server in the classical sense of the term, and may instead actually be another user device 108 as described above. Thus, by one embodiment, the infrastructure 100 can be configured such that the functions of the server 102 and a user device 108 described herein are performed on the same device, for example, one user's user device 108, perhaps being the first user's 118 PC user device 110. By this, multiple users 120 could connect to that user device 118 implementing the server 102 functionality without the need for a dedicated server 102 device. Further, the server 102 functionality could be implemented via cloud computing technologies and can be said to exist “in the cloud.” By this, in at least one embodiment, multiple various devices, perhaps the user devices 108, process various portions of the method and can communicate with each other directly or indirectly so that the method may be performed. Alternatively, the server 102 functions may be hosted via cloud-based computing such as may be provided by, for example, Google° or Yahoo!®.

The network interface 104 of the server 102 may be of any known connection type and may not specifically be a network in the typical sense of the word. For example, the connection may comprise a direct connection 122 as is depicted between the PC 118 and the server 102. This direct connection 122 may be implemented through serial bus, universal serial bus (USB), Firewire, parallel bus, CAN bus, Bluetooth, or other known direct connections. The direct 122 connection may also comprise a local area network (LAN) 122 or other local network such as a Wireless Local Area Network (WLAN), Wide Area Network (WAN), Metropolitan Area Network (MAN), System/Server Area Network (SAN), Campus Area Network or Cluster Area Network (CAN), Personal Area Network (PAN), or an intranet. These local networks can be implemented through Ethernet, Wi-Fi, Wi-MAX, or other known network communication standards.

The network interface 104 may also be configured to connect to the internet 124 to connect to one or more user devices, such as the laptop 112 depicted in FIG. 1. Further, the laptop 112 may be connected to a LAN 122 as described above, which is in turn connected to the Internet 124. For example, the depicted PC 110 and laptop 112, by one embodiment, may coexist on the same local network 122 (i.e., Ethernet or Wi-Fi) and may also communicate through that local network 122 to the Internet 124 to communicate with the server 102 as well as possibly with each other on the local network 122.

As previously described, user devices 118, such as the tablet computer 114 and the smart-phone 116, may connect to the network interface 104 of the server 102 via a wireless protocol. This may comprise, for example, a Wi-Fi connection 126 (or other known local wireless connection such as Bluetooth) as is shown between the tablet device 114 and a wireless transceiver device 128, such as a Wi-Fi router or similar. By another embodiment, such a wireless connection may comprise a cellular or telephonic connection 130 as is depicted between the smart phone 116 and the cellular base station 132 (i.e., node-B) indicated as cellular tower 132. This connection 130 may be implemented by any known current or future wireless portable data communication protocols, such as GSM, GPRS, CDMA, TDMA, Edge, 3G, 4G LTE, and the like. In turn, the wireless transceiver device 128 or cellular base station 132 may be communicatively connected to the network interface 104 of the server 102 either directly, or through the Internet 124 or other long-distance networking connections as are known in the art.

The user devices 108 typically comprise a display of some sorts, a user input interface (such as a keypad, keyboard, mouse, touchscreen, stylus, voice detection, etc), a network or digital communication interface, and at least one processing device. The user devices 108 allow their respective users 120 to connect to the server 102 and/or other users 120 to provide and perpetuate a gamified study environment as described herein.

The gamified studying environment can be provided in a multitude of different formats via a multitude of different infrastructures and configurations. For example, as described above, a central server 102 can be provided that connects to a plurality of user devices 108 servicing a plurality of users 120. In such a configuration, by one embodiment, the server 102 can operate various software or firmware modules that receive data from users 120 via their respective user devices 108, stores and processes that data, and returns results to the user devices 108 according to embodiments of the method described herein. This can be achieved by the server 102 hosting a webpage interface or a web-based application which users 120 log on to and interface with, possibly using a general web browser. The webpage can be HTML-based, flash-based, java-based, or based on any other known webpage technology or a combination thereof. By this, a user 120 needs nothing more than a standard web browser and an internet connection 124 to navigate to the address of the hosted webpage to access and interact with the server 102.

By another embodiment, a client application that is configured to communicate with the server 102 can be provided and installed on the user devices 108. The application can be provided to operate on mobile devices, such as Android® or Apple® iOS systems, or other PC or Mac platforms, in addition to the above described web-based application. The installed application can be provided in lieu of or in addition to the web-based application described above. If both are offered, then it may be convenient for a user 120 to utilize the environment when using other user devices 108 that have a web browser but not the application.

The application provides a graphical interface with which the user 120 interfaces and a means to receive and present data. Further, the application may be provided with abilities to process at least portions of the data to provide results to the user 120 rather than the user device 108 relying solely on the server 102 for the results. The application may remain in constant or periodic communication with the server 102, and/or the application may receive push notifications from the server 102 to receive data/results and may provide data to the server 102 only when requested or when new data is available to be sent. Additionally, the application may utilize volatile an/or non-volatile storage space (i.e., memory or hard disk space) of the user device 108 to allow for storage of entered, processed, or received data.

In another aspect, it may be possible for the application to enable the user 120 to interact with the application in the absence of a network connection 122, 124, 126, 130 thus allowing the user 120 to still capture, enter, process, or view data pertinent to the gamified studying environment with or without a network connection 122, 124, 126, 130 (i.e., when traveling or otherwise without access to the appropriate network). In such a situation, the application can later sync necessary data with the server 102 when a network connection 122, 124, 126, 130 is present to upload and download data to provide the user 120 with the most up-to-date information available.

By another embodiment, the plurality of user devices 108 may each have installed thereon an application as described above. The applications may all be configured to communicate with one other to allow for updating of data amongst the various user devices 108. Accordingly, in such an embodiment, a central server 102 may not be necessary and the required processing can be spread across the multiple user devices 108 based on updated data transmitted and received. Individual user devices 108 may provide and receive raw data, processed data, or a combination thereof to or from other user devices 108.

Whether the implementation be a web-based application or a local client application, the application may be configured to utilize and interface with other available applications to provide additional features, or even the core features. Examples of utilizing other applications are interspersed in the remainder of this description. Further, data transmitted between the server 102 and the various user devices 108 and between the various user devices 108 may be encrypted according to various known encryption methods to ensure the security of the users 120 and their data.

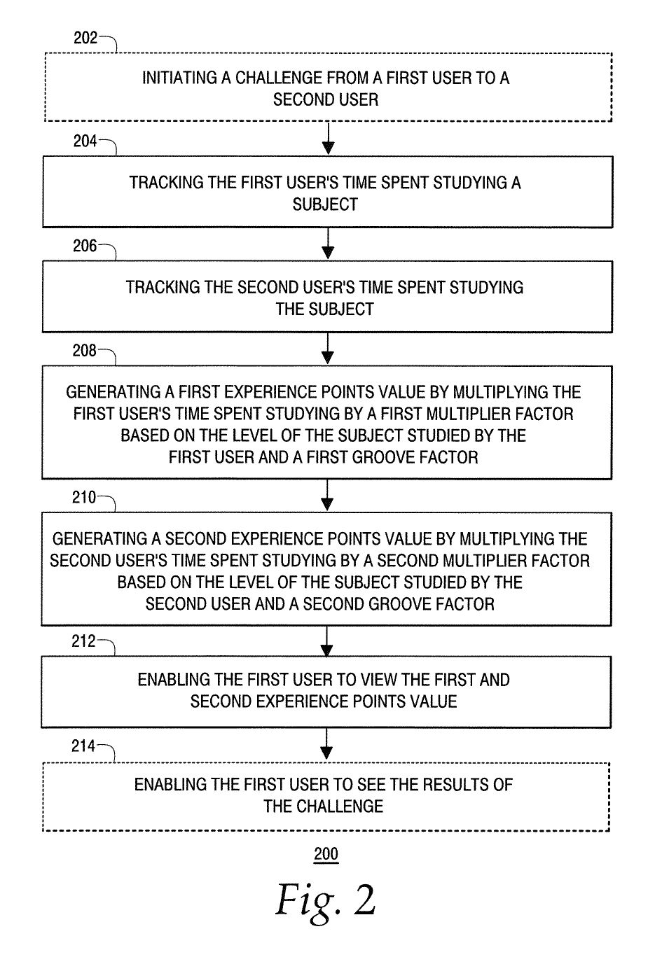

Referring now to FIG. 2, a method 200 of gamifying study time amongst a plurality of users 120 is illustrated. The method 200 optionally begins by tracking 204 a first study time spent studying a subject by a first user 118. The method includes tracking 206 at least a second study time spent studying the subject by at least a second user 134. The at least a second user 134 can comprise a single second user 134 or a plurality of users 120, such as second user 134, third user 136, and fourth user 138. For purposes of illustration and simplicity, and with brief reference to FIG. 1, the first user is illustrated as first user 118 utilizing the first user device (PC 110) and the at least a second user 134 is illustrated by user 134 utilizing a second user device (the laptop 112). However, any of the illustrated users 120, user devices 108, and network connections 122, 124, 128, 132 is equally suited to illustrate the first 118 and second users 134.

Tracking 204, 206 study time may be performed at the server 102, the respective electronic devices 108, or both. For example, tracking 204, 206 study time may comprise the server 102 computing a quantitative amount of study time. The server 102 may compute study time by operating a timer or a stopwatch (i.e., starting from zero or some other set time and simply counting the passing time) or by noting actual start and stop times (i.e., started at 7:00 PM EST and ended at 8:00 PM EST) and calculating a duration, possibly at the end of a study session and accounting for any breaks. Alternatively, tracking 204, 206 study time could also comprise an application running on a user device 108 computing the quantitative amount of study time as described above. The server 102 could then track the study time by receiving the computed amount of study time from the user device. Alternatively still, tracking 204, 206 study time could comprise the application providing the actual start and stop times of studying to the server 102 whereupon the server 102 could calculate the difference and thus the study time.

In another embodiment, tracking 204, 206 study time can comprise tracking the number of set blocks of time spent studying the subject by a user. For example, at tracker may only count how many 15-minute blocks of time a study session has lasted and may only count time once it exceeds that set block of time. The set block of time may be any suitable time frame (i.e., 5-minutes, 10-minutes, 20-minutes, 30-minutes) and may be variable based on many factors such as, for example, the age of the user 120 or the subject being studied.

Tracking 204, 206 study time may be initiated (automatically or manually) upon beginning or resuming a study session utilizing digital content viewed or experienced via the user device 108 (for example, by beginning to review an online history book or watching a provided video clip). Also, a user 120 can manually begin and end a study session, allowing the server 102 or user device 108 to calculate study time and allowing the user to study non-digital content (i.e., a physical book).

In another embodiment, other technologies may be used to determine when a user is actually studying. For example, video monitoring could be implemented, either directly or as an additional application as previous described. An example software application is Google® Glasses which can record video and identify images to ensure a user 120 is present. Eye-tracking software could be implemented to track the user's 120 eyes to ensure alertness and active studying. Study time could possibly only be awarded when these functions determine that the user 120 is present and/or alert, implying actual studying is occurring. By other embodiments, the system 100 could implement neurofeedback or biofeedback to monitor brain waves or other biological functions during studying. This could be achieved with EEG equipment or other sensors, which could possibly be embedded in clothing, implants, nanomedical devices, or otherwise configured to sense the various conditions of the user 120 during study.

Study time can comprise the amount of time a user 120 puts into the object of study. By another embodiment, study time could comprise the amount of time a user 120 puts into practicing an object of practice. Generally, study time is intended to improve the user's 120 knowledge of or competency in a subject. This could comprise academic knowledge such as understanding of history, English, math, sciences, social studies, foreign languages, or any other subject. Practice time may comprise practicing foreign languages, mathematics problems, a musical instrument, or other academic pursuits, to name a few, with the intent of increasing the user's 120 knowledge of or competence in the subject.

Study time as described herein includes many forms of studying, including studying of online digital content provided to the user 120 or of other media (online or tangible) according to the curriculum of the subject or a to-do list. Studying may include interactive and/or adaptive learning, interspersed questions, flash cards, rote learning, reading, condensing information, summarizing, outlining, visual imagery, acronyms and mnemonics, exam or test strategizing, reviewing, quizzing, call and response, feeling, touching, and other known studying techniques commonly or uncommonly employed to aid users 120 in excelling academically. Learning could even incorporate utilizing foglet technology to provide physical or semi-physical visual and/or interactive presentations of information, models, coaches or teachers, or virtual and real opponents, etc.

Returning to FIG. 2, optionally, the tracking 204, 206 may be performed in response to initiating 202 a challenge from a first user 118 to a second user 134, the details of such challenge proceedings being described later in this disclosure.

The tracked first study time is multiplied 208 by a first multiplier factor to generate 208 a first experience point value. Similarly, the second study time is multiplied 210 by a second multiplier factor to generate 210 a second experience point value. Multiplication can occur in real time (continuously or periodically) as the study time is tracked, or multiplication can occur once a study session has ended and the final study time for that study session has been tracked.

The first multiplier factor is related to a level of the subject at which the first user 118 studied during the first study time. Similarly, the second multiplier factor is related to a level of the subject at which the second user 134 studied during the second study time. For example, the first 118 and second users 134 may be studying mathematics, and the first user 118 may be studying at a first level (i.e., “level 1”) and the second user 134 may be studying at a second level that is higher than the first level (i.e., “level 4”). The higher level may represent a more difficult degree of study, involving more complicated or difficult subject matter, problems, and/or topics. The levels may be decided by the provider of the gamified studying environment or a teacher or other user 120 with administrative privileges with respect to the subject.

By way of non-limiting example, studying at level 1 may correspond to a multiplier factor of 100. Thus, the first user 118 above studying at level 1 for one hour may earn 100 experience points (e.g., 1 hour×100 multiplier factor). The second user 134, however, studied at level 4, which may have a multiplier factor of, for example, 120. Thus, the second user 134 studying at level 4 for one hour may earn 120 experience points (e.g., 1 hour×120 multiplier factor).

One of skill in the art will recognize that various values, factors, and multipliers can be associated with various multipliers dependant at least upon the level studied and the intended weighting for various levels. The various multipliers may increase or decrease with study level linearly, constantly, quadraticly, exponentially, logarithmically, or by any other function-based or arbitrary relationship. The values provided herein represent example values for illustration and, although they may be workable in certain settings, other settings may require alternate values.

The first multiplier factor is also related to a first groove factor and the second multiplier factor is also related to a second groove factor. These groove factors, explained in more detail below, can increase or decrease the multiplier factor to incorporate other effects beyond solely the level studied in the subject. They can take into account continuous time spent studying, breaks, answers to questions, awards, previous performance, and other aspects. By way of non-limiting example, a user may have studied for 2 consecutive 15-minute blocks which increased their respective groove factor, perhaps from 1 to 2, or from 0 to 10. The groove factor is then included in the calculation of the multiplier factors. In one embodiment, such calculation could be by way of addition with the calculation based on the level of study. In keeping with the above example, assuming a groove factor is increased from 0 to 10 and the second user 134 studied at level 4 at the example 120 second multiplier factor, the portion of the second multiplier factor attributable to the subject study level might be 120 plus the additional 10 groove factor, yielding a calculated second multiplier factor of 130.

By another embodiment, the groove factor could be multiplied with the subject level value to yield the multiplier factor. Referencing the above example again and assuming the groove factor was increased from 1 to 2, the 120 value may be multiplied by 2 to yield a second multiplier factor of 240, which in turn may result in 240 experience points for one hour of study by the second user 134. Alternatively, the groove factor could be multiplied with a portion of the multiplier factor attributable to the subject level studied that is above a certain baseline. For example, a set baseline may be 100, possibly the equivalent of studying at level one. Anything above that level then could be multiplied by the groove factor, resulting in a calculation as follows: 100+(20×2)=140, resulting in 140 experience points for one hour of study for the second user 134. Many other options exist as how to create the multiplier factor based on the level of the subject studied and the groove factor by mathematically combining the portion of the multiplier factor attributable to the subject study level and the groove factor, and the foregoing examples are not to be taken in a limiting sense.

Experience point values, as well as study time, groove factors, multiplier factors, and other tracked, calculated, or derived values may be stored in volatile or non-volatile electronic storage, though non-volatile storage may be beneficial in settings where scores may be tallied over many sessions. The values may be stored cumulatively or as separate entries with cumulative values provided by aggregating various ones of the experience point values, study times, and groove factors.

To provide the gamified environment, in one embodiment, the method includes providing to the first user 118 or enabling 212 the first user 118 to view both the first experience points (earned by the first user 118) and second experience points values (eared by the second user 134). Also, by other aspects, some or all experience values earned by individual users 120 of a certain subsection of users (for example, a single math class, or the entire 8th grade student body) can be provided to each user 120 in that specified subsection. By another embodiment, wherein a challenge had been initiated, the first user 118 and/ore the second user 134 are enabled 214 to view the results of the challenge, for example, possibly seeing who won and by how much. So configured, the first user 118 (and other users 120) may view their earned experience points in comparison with their peers to allow them to measure their performance against their peers. This gamified aspect beckons to a person's competitive nature and turns studying from a chore to a playful experience whereby they are enriched with knowledge and are constantly setting new bars for their peers and themselves.

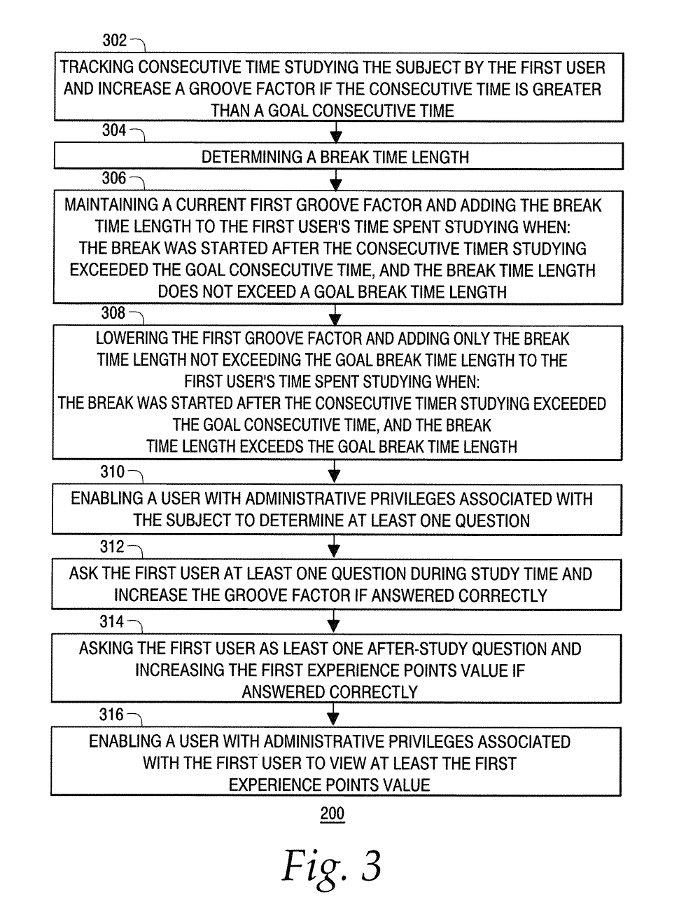

Referring now to FIG. 3, additional aspects of the method 200 of gamifying study time are illustrated in accordance with various embodiments. As was discussed briefly above, the method 200 contemplates tracking 302 consecutive time studying the subject by a user 120 and increasing 302 that user's 120 groove factor if the consecutive time is greater than a goal consecutive time. For example, the first user 118 may study for a consecutive amount of time, without taking breaks or ending the study session, which value may be 30 minutes and counting. If the goal consecutive time is set to 30 minutes, for example, then once the first user 118 has reached the 30 minute mark, the groove factor may be increased 302. This indicates that the first user 118 is in a “study groove.” Certain studies show that the longer a student studies a topic (up to a certain time), the more likely they are to retain the knowledge or develop their skills in a meaningful way. Thus, by increasing 302 a user's 118 groove factor for studying for consecutive blocks of time that exceed the goal consecutive time, the user 118 is encouraged to study consecutively for at least those goal times.

Other goal consecutive study times are possible and may be set by a teacher or a provider of the gamified study environment. Multiple goal consecutive study times within a study session may be set or selected, allowing for further increased groove factors after the user 118 studies for longer periods of time. These multiple goal consecutive study times may be periodic, for example, every 30 minutes, or may be increasing or decreasing, for example, 45 minutes for the first goal, then 30 minutes for the second, then another 20 minutes for the third. Also, the goal consecutive time(s) may be determined by many factors, including the age of the user 118, the studied subject, the experience of the user 118, a setting by the teacher, a real-time or periodic calculated performance factor of the subsection of users 120, or any other factor.

In another aspect, the method includes determining 304 a break length. This determination 304 may be made by starting a break time tracker in response to a user 120 taking a break from studying the subject and stopping the break timer to determine 304 the break length in response to the user 120 ending the break. The user 120 may be provided a button or plurality of buttons to indicate the start and stop of a break. A break timer may be displayed during the break so that the user 120 can monitor the break time. By other embodiments, the break time may be determined automatically, possibly by calculating a period of inactivity or determining that the user 120 is not present or paying attention.

By one embodiment, if a break is started after the consecutive time studying the subject is greater than a goal consecutive study time, meaning that the user 120 has studied consecutively at least for the goal consecutive study time, for example, 30 minutes, then the duration of the break time may be added 306 to the user's 120 time spent studying the topic. In essence, in terms of tallying time spent studying, it is as if the user 120 did not stop studying. By this a user 120 is encouraged to at least study for the goal consecutive time before taking a break, thus increasing their effectiveness.

By another embodiment, if the break time length is less than a predetermined goal break time length, for example, 15 minutes, then the entirety of the break time length can be added 306 to the user's 120 time spent studying the topic. However, if the break time length exceeds the predetermined goal break time length, then only the break time length not exceeding the predetermined goal break time length may be added 308 to the user's 120 time spent studying the topic. Alternatively, if the break time length exceeds the predetermined goal break time length, then no portion of the break time length is added to the user's 120 time spent studying the topic. By this, a user 120 is encouraged to keep their break durations to a preset length or less, thus allowing the user 120 a brief reprise from studying, but not so long that they loose all the accumulated effects of consecutive studying. By most embodiments, but not necessarily all, the consecutive study time counter will start over upon resuming studying.

Dependent on the break time length time, the user's 120 groove factor may be lowered 308 or maintained 306. By one aspect, the user's 120 current groove factor may be maintained 306 in response to the break timer being started after the consecutive timer spent studying the subject by the user 120 is greater than at least the first preset goal consecutive study time and the break time length does not exceed the predetermined goal break time length. For example, if the goal consecutive study time is 30 minutes and the goal break time length is 15 minutes, once the user 120 studies for at least 30 minutes, their groove factor can be increased 302. If they start a break after that 30 minute point, also, the newly increased groove factor will be maintained 306 at the elevated rate as long as they do not exceed the allotted 15 minute break time. Conversely, if the break time does exceed the predetermined goal break time length, then the user's 120 groove factor can be lowered 308. It could be lowered 308 possibly to the same groove factor it was at just prior to it being increased 302 upon achieving the goal consecutive study time, or possibly to a groove factor that existed at the beginning of the study session, or any other lowered groove factor. Thus, the user 120 is doubly encouraged to start a break only after having studied consecutively for a certain amount of time and to keep their break to the minimum length needed.

In other embodiments, sensors may be employed to sense the readiness of a user 120 to begin a break or resume studying after a break. Such sensors may comprise EEG sensors, brainwave sensors, or sensors configured to detect other physical aspects of the user 120. This would create a more exact or customized calculation of when a user 120 is ideally ready to break or resume studying. Further, these sensors could be used to determine, for example, how often certain brain activity or brainwaves are achieved, blood flow to brain, movement accuracy during practice, stress levels, or other information relative to or indicative of studying effectiveness. Further experience points or groove factors can be awarded depending on these actual measured physical responses to studying, which may indicate how hard the user 120 is actually studying. Additionally, these sensors could provide data regarding study habits (possibly in addition to or coupled with performance or grades) that may be warehoused and used in research studies involving study habits and the like.

With continuing reference to FIG. 3, in another embodiment, a third user with administrative privileges associated with the subject (“subject administrator”) is enabled 310 to determine at least one question. For purposes of illustration, third user 136 is assumed to be the subject administrator 136. Example users 136 with administrative privileges associated with the subject are teachers, principles, curriculum developers, and providers of the environment, though other users 120 can be subject administrators 136. The questions, most often pertaining to the subject or material studied in a study session, can be stored at various places in the system, possibly at the server 102. The subject administrator 136 can draft their own questions or can select questions from a set of pre-made questions pertaining to that subject. The questions can be multiple choice, true/false, fill-in-the-blank, short answer, long answer, or other known question types. The questions can range in difficulty and can be stand-alone questions or be part of a larger set of questions as part of a quiz test, or exam. Answers to the questions may be graded automatically by the system 100 (the server 102 and/or the user devices 108) or may require the subject administrator 136 (teacher) to grade them at a later time. Users 120 may be able to directly interface with the environment to answer the questions directly, or may be required to do work on other media, such as paper or a word processor, and provide a scanned, photographed, or other electronic version of their answers to the system 100 or server 102 for grading by the subject administrator 136 or the server 102 itself. By one approach, users 120 could be awarded different experience points or groove factors dependent upon the depth of the question or the user's 120 answer, allowing for at least partial credit where possible and awarding better answers with higher increases.

The questions can be asked to users 120 at various points during a study session. For example, the questions can be situated so that they are asked at specific points during studying, for example, at the end of a section or chapter, or randomly throughout the study session. In one embodiment, the system will ask 312 the user 120 at least one question during study time and increase 312 the groove factor, provide additional experience points, or provide a different kind of points called “knowledge points” (discussed later) if answered correctly.

In another embodiment, questions can be asked 314 at the end of a study session as an after-study question, possibly in a “cool-down” portion as a review of what was studied in that session or other previous sessions. If the user 120 answers these questions correctly their experience points value can be increased 314, groove factor increased, or knowledge points awarded. If the groove factor is increased, it could carry over until the following study session and/or apply retroactively to the previous study session.

In another aspect, users 120 can be provided with a variety of study modes, including but not limited to solo-study mode, challenge mode, and team-up mode. Solo-study mode may comprise accumulating experience points primarily as described above. Other variations may exist, but the primary goal of the user 120 in solo-study mode may simply be to accumulate as many experience points, awards, or study time as possible. This may be done in an attempt to improve or maintain their ranking among their peers or other users 120 within the subsection studying the same subject or subjects, possibly achieving the highest rank in that set of peer users 120.

Challenge mode may include a head-to-head study challenge with one or more other users 120. Alternatively, groups of users 120 could challenge other groups in a similar manner. The challenge could comprise a single study session, multiple study sessions, a set duration of length, or a set number of study hours or experience points. In one embodiment, a first user 118 (or a first group of users) could select one or more other users 120 (or groups of other users 120) to challenge to see who can accumulate the most study time or experience points over a set time frame (for example, who can accumulate the most study time over the next week). By another embodiment, a user 118 can challenge one or more other users 120 to see who can be the first user to achieve a set amount of study time or experience points (for example, who can be the first user to accumulate 10 hours of study time). Possibly, the challenger user 118 would select the subject and the challenge user, for example second user 134, would select the length of time and/or goal, or vice versa. This may be provided with an end date so that the challenge will end at some point, whereupon a winner will be determined. Other possible challenges may include one based on study time or experience points and a time limit, and may possible allow for multiple winners. For example, a first user 118 may challenge a second user 134 and/or other users 120 to see who can get to 10 hours of study time within the next week, wherein whoever does so (possibly multiple users 120) within the next week will be a winner of the challenge.

By another embodiment, challenge mode may be based on performance during one or more study sessions. For example, a first user 118 can challenge one or more other users 120 to a study session wherein whoever gets the most number of groove questions correct during the study session and/or the most number of questions correct on a post-study session quiz will be the winner of the challenge. This type of challenge is based more on quality of study and performance as opposed to length of study. Both types of challenges can be provided as well as others challenge types not disclosed herein but contemplated by this disclosure.

By most embodiments, during a challenge, all users involved may, though not necessarily, accumulate study time and experience points as normal (i.e., as during solo-study mode) to be added to their running totals. However, whoever wins the challenge may be awarded extra experience points, a groove multiplier (possibly to be applied during their next study session or retroactively), an award or badge, or knowledge points which may be used to “purchase” items or upgrades.

Knowledge point purchases may possibly be solely within the gamified study environment (for example, an interesting backdrop or graphic use interface skin) or other virtual items, or may be used to purchase physical items (for example, candy or extra recess time in a classroom setting). To further encourage the gamified nature of the study environment, users 120 may be able to wager against other users 120 with their knowledge points in relation to challenges or other aspects. The wagered knowledge points could be awarded to the user 120 who is the victor of a challenge, or could be split amongst multiple users 120 privy to the wager, though the different types of wagering options are unlimited by this disclosure. Allowing wagering further enhances the user experience and provides further motivation to excel.

Awards or badges may be given to challenge winners or at various other times during study of a subject, for example, to the user 118 or users 120 with the highest number of experience points after the first exam, the user 118 with the highest grade on a quiz, or at the end of the class. The awards or badges can be displayed with in a virtual trophy case in the user's 118 bio that is viewable to the user 118 and possibly other users 120 and administrative users 120.

In another embodiment, a team-up mode provides the ability for multiple users 120 to team up together during a study session. Though still competitive overall, this mode may present an opportunity for users 120 to cooperate to achieve higher efficiency in studying by allowing a group of users 120 to work together to finish a set amount of work, for example, maybe during a single or multiple study sessions. In one aspect, after forming the team, which may be formed well in advance either by various users 120 or a subject administrator 136 and which may be temporary, revolving, or permanent, each user 120 of the group is assigned a segment or sub-section of the study session to learn and subsequently teach to the other users 120 in the group. The users 120 may each learn their individual segments and develop a presentation or lesson plan of sorts to teach the other users 120 the content of the segment. Each participating user 120 teaches the other users 120 via a presentation or other teaching mode the content of the segment. Each teaching presentation can be live in person, live over a video or audio stream across the plurality of user devices 108, or even possibly recorded for viewing at a later time. Convenience and efficiency is therefore increased for the group during the team-up sessions because users 120 can be remote and can learn the subject matter from other users 120 via a streamed lecture-style presentation rather than digesting the readings or other material themselves. After each user 120 has presented their material, possibly lasting for a set time segment of 15 minutes (though other time durations are possible and appropriate in various settings), the users 120 of the team may take a quiz on the material covered in the study session (including all segments or sub-sections).

Users 120 in the team-up group may accumulate study time as if during normal solo-mode study, possibly inclusive of time spent learning during other user's presentations, but certain factors may or may not affect the experience points or other awards. For example, a multiplier factor for the study time accumulated during the team-up study session may be dependent upon the level of the subject at which the team-up group studied at. Similarly, it may be dependent on individual or group performance on the post-study session quiz. Further, the results of the quiz could impact a groove factor, possibly for future study sessions or team-up study sessions.

By another approach, a different user 138, perhaps a parent, with administrative privileges associated with the first user (“parental administrator,” though this administrator is not limited to parents, per se) is enabled 316 to view at least the first user's 118 experience point value through a user device 108. For illustration purposes, the fourth user 138 operating user device 116 in FIG. 1 is identified as the parental administrator. This parental administrator 138 is someone with authority over the first user 118 or responsibility for the first user's 118 education. For example, the parental administrator 138 may be a parent or guardian of the first user 118, or perhaps a counselor, principle, a teacher, or other person who is interested in the user's performance in the subject or academically overall. This parental administrator 138 may have access to other information pertaining to the first user 118 such as time spent studying the subject by the first user 118, groove factors, historical study sessions, progress, grades, study session durations, past accomplishments, performance on tests versus how much time was spent studying for them, homework assignment status, quizzes and questions completed, and many other metrics. In some embodiments, this parental administrator 138 will have access to all or most of the same information that a subject administrator 136 (for example, a teacher) would have, but would limited to their respective user or child, the first user 118 in this example. Much of this information can be provided in graphs or other visual renderings beyond simple lists of information. The parental administrator 138 may also have other administrative abilities, such as the ability to plan study times or sessions or homework assignments for the first user 118. They may be provided with a list of homework assignments and their accompanying due dates. A calendar may be provided allowing the parental administrator 138 to drag assignments into the calendar to account for required project or study time, possibly spanning multiple days. The parental administrator 138 may also be able to set up a reward system by establishing goals to be reached by the first user 118 (for example, 12 hours of study time a week or certain grades achieved) and set up corresponding rewards (for example, monetary or privilege based) to encourage the first user 118. Such reward plans may be even split into multiple tiers dependent on the amount of studying or the performance of the student. The parental administrator 138 may also be able to manage notifications provided to the first user 118, such as when to study, how close a homework deadline is, and how far ahead or behind the first user is in homework.

The parental administrator 138 may be able to view current study information, such as whether the first user 118 is presently studying and for how long, what current page or section, how many groove factor increases or experience points accumulated or groove questions answered correctly, incorrectly, or ignored, or when the last study session was and the results of that session. Accordingly, the parental administrator 138 is given additional information and power to be an additional force in ensuring the first user 118 is studying properly.

In a similar manner and in another embodiment, the subject administrator 136 (for example, the teacher of the subject) is provided with features beyond the aforementioned ability to determine questions. The subject administrator 136 is provided with the ability to view almost all, if not all, aspects available to the parental administrator 138 described above. For example, the subject administrator 136 can view individual or multiple user 120 bios that indicate the performance of the user 120 including past progress as well as current progress (for example, what the user 120 is currently working on and how long) as well as other information. The subject administrator 136 may be able to establish goals and/or rewards for individual users 120 or groups of users 120 to put forth expectations of those users 120. The subject administrator 136, however, will be able to view not just the first user's 118 profile and performance information, but all users 120 currently associated with the subject (for example, all 8th grade math students in the teacher's class).

Not only will the subject administrator 136 be able to view various users' 120 performance, but they will be able to establish the curriculum and study plans for the subject. The subject administrator 136 may be able to upload entire year-long lesson plans or portions thereof as well as homework assignments, other handouts, or other to-do list items. Subject administrators 136 may be able set timers for various assignments or sessions so that they are not accessible except after or during a specified date or time or only after previous assignments have been completed by the user 120. This can help ensure the user 120 has at least the minimal understanding required to proceed to more difficult or complex materials. The curriculum and lesson or study plans can be edited or altered accordingly and can be made available for users 120 to view as needed. The subject administrator 136 may be able to establish various levels of difficulty when developing study plans or questions, with more difficult levels yielding higher experience point values or groove factors. The subject administrator 136 may be able to communicate directly through messages or chat services with the users 120 or the parental administrators 138 to communicate concerns, grades, or give notification of upcoming homework or assignments.

The subject administrator 136 may also be provided with the ability to view and grade completed homework assignments uploaded to the environment, quizzes, study questions, groove questions, after-study questions, or other material that may require manual grading. The subject administrators 136 can record the grades for the assignments for each user 120. Thus, the subject administrator can act as the arbiter of study sessions, determining what to award a user 120 or groups of users 120 (for example, teams of users 120) based on performance or other factors, or determining winners of various challenges.

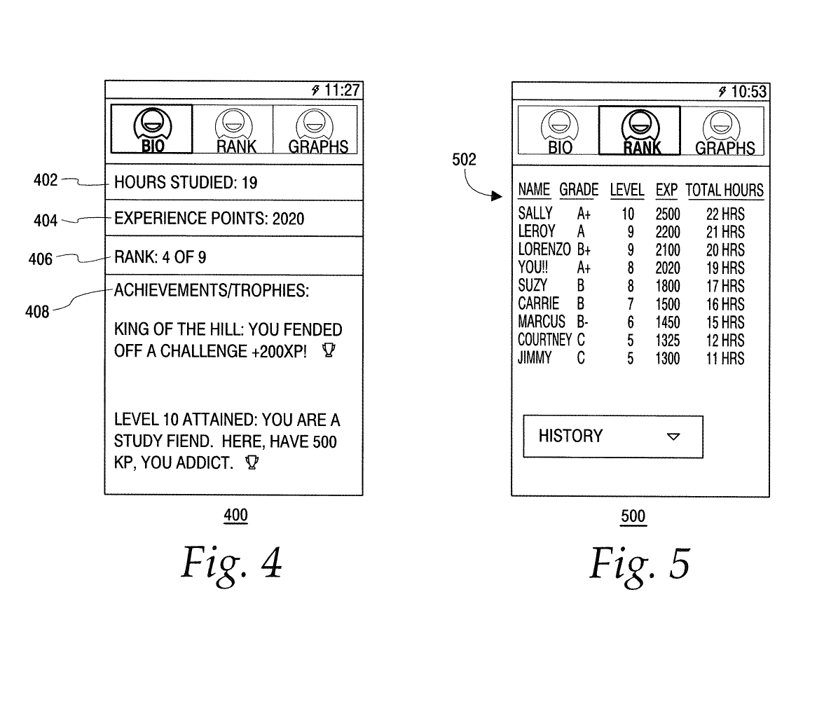

Turning now to FIGS. 4-7, various user interfaces 400, 500, 600, 700 in accordance with various aspects are illustrated. A user 120 can start the gamified study environment application or navigate to the gamified study environment webpage, whereupon the user 120 can logon to the system. A logon can be provided by a subject administrator 136, a parental administrator 138, or created by the user 120. If a new account is to be crated, the user 120 can select which type of account they would like to set up, for example, a student user account, a subject administrator account (teacher account), or a parental administrator account. A subject administrator 136 may select various aspects pertaining to their school, geographical area, subject, or select specific student users 120 in their class, amongst other options. A parental administrator 138 may search for and select the user 118 which they are interested in and associate their account when that user 118. A student user 118, upon setting up the account, may choose their school or geographical area, amongst other options. Possibly, instead of a full “pro” version, the user 118 could enter a trial period whereupon they would input basic information about themselves and select a certain number of generic or trial courses to try. This trial period could be free or in exchange for a nominal fee. The remainder of this description centers on the full “pro” student user account, which may be provided for a fee or free, though many aspects may typically be provided in the trial account as well.

Once logged on, the student user, such as first user 118, may be provided a bio page 400 or home/base page. An example of such a bio page 400 is shown in FIG. 4. This bio page 400 may include dashboard information relative to current overall or specific performance. Such information may include statistics, hours studied 402, experience points 404, rankings 406, awards, accomplishments, or trophies 408, groove factors, graphs, list of subjects studied and the level attained, hours invested, and experience points earned in each subject, and major milestones. From this bio page 400, the user 118 may be presented with other options, such as purchasing items or upgrades with knowledge points, starting a course, begin studying, selecting subjects to study. Many other options may be present and available to the user 118 to select, navigate to, view, or interact with, and some of the above listed options may be utilized or viewed through navigation of various sub-screens.

FIG. 5 illustrates a user ranking page 500 in accordance with various embodiments. The user 118 may be presented with their ranking within a list 502 of other users 120, possibly limited to a class, but possibly expandable up to the entire school, city, district, county, state, nation, or world wide listing 502. The ranking list 500 may be broken down by specific subject. Optionally, the user 118 may be able to select individual users 120 within this ranking list 502 (or within other listing of users 120) to view their respective bio pages 400 to see other information associated with those users 120 (such as time studied, experience points, awards, etc). Users 120 could select other users 120 to “follow” to pace their experience. Accordingly, the followed users 120 could be given notification that they are being followed. This gives extra incentive to each user 120 to excel.

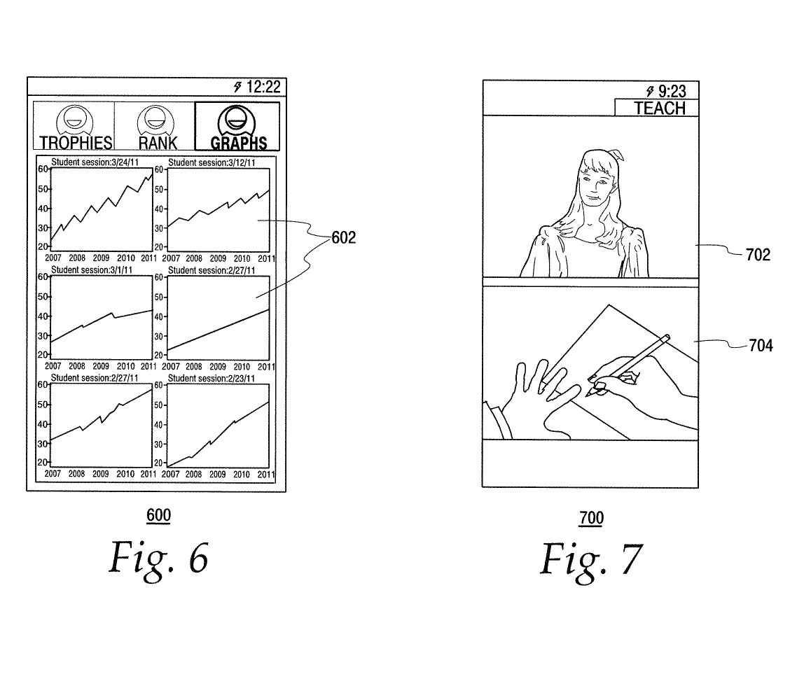

FIG. 6 illustrates a graphs page 600 in accordance with various embodiments. Single or multiple graphs 602 could be presented on one screen or multiple screens, with the graphs 602 being scalable and enlargeable upon selection and interaction. Various graphs 602 could be presented for different subjects or different statistics, raw or derived. The information on the graphs 602 may comprise hours studied per week or day across longer timelines. For example, various grades received on tests, projects, quizzes, and the like could be overlaid on top of a weekly-hours-studied line to show on a single graph 602 how study time relates to performance. Other graphs 602 may illustrate experience points earned per week, or hours studied per day, average groove factor maintained, length of breaks, days early or late on projects or homework, ranking, data relating to sensor readings taken during study sessions regarding physical reactions of the user's body during study, or any other measurable data that is capable of being graphed in a useful or interesting way. Various axes of the graphs could comprise timelines (such as days, weeks, months, years), grades received, hours studied, or combinations of those or other metrics. For example, a y-axis might represent hours studied per grade letter received, and the x-axis might represent a timeline, thus illustrating the change in hours studied versus grade received over time (possibly showing the changing study efficiency of the user over time). Optimum or goal levels of performance may be shown on the various graphs 602 showing where the user 118 is excelling or requiring additional effort.

From various pages, including possibly the bio page 400 of FIG. 4, a user 118 can decide to start a study session or start a course. The user 118 can select the subject and/or the study mode in which they would like to study. For example, if the user 118 select solo-study mode, they may be able to choose course materials and/or select an amount of time to study or start a stopwatch timer. Before beginning the study session or during the study session, various tips or reminders may be presented to the user 118 to help aid them in preparing for studying. For example, a screen may give tips regarding studying indicating that it is preferred to eliminate distractions, keep noise levels down, and other pertinent tips. Upon starting the study session, a timer may be displayed on screen at all times. Various questions may pop-up at random or preset times or dependent upon the user's 118 progress through the material. Other information possibly presented to the user 118 during study sessions are the current level in the subject, a running total of the time or experience points accrued, and experience progress bar, a groove meter correlating to a current groove factor, a list of other students who may be presently online or studying, and a break button. Upon ending the study session, the user 118 may be presented with post-study questions, as discussed above. Lastly, a user 118 may be presented with a summary of the study session prior to being sent back to the bio page 400 or home page, possibly indicating how long studied, how many experience points earned, a subject level achieved, indication of awards, and a ranking in the class, though other options are possible.

If the user 118 chooses challenge mode, the user 118 can resume or renew a previous challenge (for example, “double down”) or initiate a new challenge. The user 118 may be then presented with a list of other users 120 which the user 18 can challenge, that list possibly being other users 120 in their class or even users 120 worldwide. This list may be presented in order of rank, such as the ranking list 502, or have other pertinent performance information associated with the other users 120. The user 118 can then select one or more other users 120 to challenge. A notification can be sent to the recipient or recipients of the challenge and the challenge terms can be determined and the challenged commenced. The challenge may continue within these screens or simply run in the background as the users 120 study in normal or other modes with their earned experience being applied toward the challenge totals as well as normal solo-study totals.

If the user 118 chooses team-up mode, the user 118 may enter a team-up room. The user 118 may already be part of an existing team or may initiate the creation of a new team by selecting other users 120 to join the new team. Various notifications can be sent to the other users 120 and scheduling can be determined so that the users 120 can select a time to study together. Individual users 120 can be provided with study sessions according to their assigned segment of the total team-up session. Each participating user 120 can then review their specific topic and prepare a lesson plan. Upon commencement of the group study at the scheduled time, individual users 120 may be provided with a video stream 702 of the selected presenting student, as is shown in video page 700 of FIG. 7. Other views of video streams may be possible on the video page 700, such as a view 704 of a paper upon which the teaching user 120 is drawing. Alternatively, the other views 704 may be from the individual user's 118 own camera so that the user 118 can see what other users 120 might see when their teaching session starts. Other information on the video page 700 or other pages associated with the team-up study session may include total study time accrued this session, subject level, total experience points, subject the student is presenting, and a break button. If a user 118 selects the break button, the user 118 may have the option to explain why (for example, bathroom break, emergency, etc.) and the group may have the ability to take a group break much as explained above. After all users 120 have presented, each user 120 is presented with a quiz, the results of which are uploaded to the server 102. Upon completion of the team-up study session, the users 120 may be presented with a summary page as described above.

The user interfaces 400, 500, 600, 700 can be modified and configured to suit the needs of either the subject administrator 136 (teacher) or the parental administrator 138. For example, the subject administrator 136 may have access to the information available on each bio page 400 for each user 120 in their class without limitations. Additionally, the subject administrator 136 will have other interfaces by which they can upload or edit lesson plans and homework assignments, grade assignments, or perform other tasks associated with the teaching of a subject or the administration of a group of student users 120. The parental administrator 138 may have access to the bio page 400 or other information related solely to the first user (their child), such as ranking, graphs, and other information.

Accordingly, a gamified study environment is provided such that users 120 are encouraged to excel at studying or academic performance by tapping into the competitive nature of people. As described herein, the gamified study environment motivates users 120 to increase the amount of time spent studying and to lengthen the periods of time spent studying as well as to push themselves as to the level at which they study within the subject due to level-weighted tracking. Thus, the acamdemic achievement of both the individual user 120 as well as a group of users 120 is increased as the individual user 120 and the entire group are encouraged to study.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for gamifying study time amongst a plurality of users, the method comprising:
tracking at one or more processing devices a first study time comprising time spent studying a subject by a first user utilizing a first user device;
tracking at the one or more processing devices at least a second study time comprising time spend studying the subject by at least a second user utilizing at least a second user device;
multiplying at the one or more processing devices the first study time by a first multiplier factor relating to a level of the subject at which the first user studied during the first study time and a first groove factor to generate a first experience points value;
multiplying at the one or more processing devices the at least a second study time by at least a second multiplier factor relating to at least a level of the subject at which the least a second user studied during the at least a second study time and at least a second groove factor to generate at least a second experience points value;
enabling by the one or more processing devices the first user to view the first experience points value and the second experience points value.

2. The method of claim 1 further comprising asking the first user at least one after-study question after the first study time and adding additional experience points to the first experience points total in response to the first user answering the at least one after-study question correctly.

3. The method of claim 2 wherein the at least one after-study question is determined by at least a third user having administrative privileges associated with the subject.

4. The method of claim 1 further comprising:
tracking at the one or more processing devices consecutive time spent studying the subject by the first user; and
increasing the first groove factor in response to the consecutive time spent studying the subject by the first user being greater than at least a first preset goal consecutive study time.

5. The method of claim 4 further comprising:
starting at the one or more processing devices a break time tracker in response to the first user taking a break from studying the subject;
stopping at the one or more processing devices the break time tracker in response to the first user ending the break from studying the subject and determining a break time length in response to the first user ending the break;
maintaining the current first groove factor and adding the break time length to the first study time in response to the break timer being started after the consecutive time spent studying the subject by the first user is greater than the at least a first preset goal consecutive study time and the break time length being less than a predetermined goal break time length; and
lowering the first groove factor and adding only the break time length not exceeding the predetermined goal break time length to the first study time in response to the break timer being started after the consecutive time spent studying the subject by the first user is greater than the at least a first preset goal consecutive study time and the break time length being more than the predetermined goal break time length.

6. The method of claim 1 further comprising:
asking the first user at least one question related to the subject during the first study time; and
increasing the groove factor in response to receiving a correct answer from the first user.

7. The method of claim 1 wherein tracking time spent studying the subject by the first user further comprises tracking the number of set blocks of time spent studying the subject by the first user.

8. The method of claim 1 further comprising:
initiating at the one or more processing devices a challenge from the first user to the at least a second user, the challenge comprising at least one of being the initial user to achieve a determined experience points value and being the user with the highest experience points value at the termination of a determined challenge time frame; and
enabling by the one or more processing devices the first user and the second user to view a results of the challenge.

9. The method of claim 1 further comprising enabling a third user with administrative privileges associated with the first user to view at least the first experience points value.

10. An apparatus comprising:
at least a first network connection configured to connect to a first user device and at least a second user device;
at least one processing device operatively connected to the network connection and configured to:
track a first study time comprising time spent studying a subject by a first user of the first user device comprising;
track at least a second study time comprising time spent studying the subject by at least a second user of the at least a second user device;
multiply the first study time by a first multiplier factor relating to a level of the subject at which the first user studied during the first study time and a first groove factor to generate a first experience points value;
multiply the at least a second study time by at least a second multiplier factor relating to at least a level of the subject at which the least a second user studied during the at least a second study time and at least a second groove factor to generate at least a second experience points value;
communicate to the first user device the first experience points value and the second experience points value for display thereon.

11. The apparatus of claim 10 wherein the at least one processing device is further configured to:
communicate to the first user device at least one after-study question relating to the subject for the first user to respond to after the first study time; and
add additional experience points to the first experience points total in response to the first user answering the at least one after-study question correctly.

12. The apparatus of claim 11, wherein the at least one after-study question is determined by at least a third user having administrative privileges associated with the subject.

13. The apparatus of claim 11, wherein the at least one processing device is further configured to:
track consecutive time spent studying the subject by the first user; and
increase the first groove factor in response to the consecutive time spent studying the subject by the first user being greater than at least a first preset goal consecutive study time.

14. The method of claim 13 wherein the at least one processing device is further configured to:
start a break time tracker in response to the first user taking a break from studying the subject;
stop the break time tracker in response to the first user ending the break from studying the subject and determine a break time length in response to the first user ending the break;
maintaining the current first groove factor and adding the break time length to the first study time in response to the break timer being started after the consecutive time spent studying the subject by the first user is greater than the at least a first preset goal consecutive study time and the break time length being less than a predetermined goal break time length; and
lowering the first groove factor and adding only the break time length not exceeding the predetermined goal break time length to the first study time in response to the break timer being started after the consecutive time spent studying the subject by the first user is greater than the at least a first preset goal consecutive study time, and in response to the break time length being more than the predetermined goal break time length.

15. The apparatus of claim 10 wherein the at least one processing device is further configured to:
communicate to the first user device at least one question related to the subject to be asked to the first user during the first study time; and
increase the groove factor in response to the first user device receiving a correct answer from the first user.

16. The apparatus of claim 10 wherein the processing device is further configured to:
track time spent studying the subject by the first user of the first user device by tracking the number of set blocks of time spent studying the subject by the first user of the first user device.

17. The apparatus of claim 10 wherein the processing device is further configured to:
initiate a challenge from the first user to the at least a second user, the challenge comprising at least one of being the initial user to achieve a determined experience points value and being the user with the highest experience points value at the termination of a determined challenge time frame.

18. The apparatus of claim 10 wherein the processing device is further configured to:
enable a third user with administrative privileges associated with the first user to view at least the first experience points value.
